(19) United States
(12) Patent Application Publication
(10) Pub. No.: US 2026/0042693 A1
(43) Pub. Date: Feb. 12, 2026

(54) CONDITIONING METHOD FOR DEEP DEWATERING OF SLUDGE FROM MUNICIPAL WASTEWATER TREATMENT PLANTS

(71) Applicant: SHANGHAI JIAO TONG UNIVERSITY, Shanghai (CN)

(72) Inventors: Nanwen Zhu, Shanghai (CN); Jinwen Hu, Shanghai (CN); Huabo Gong, Shanghai (CN); Ruming Wang, Shanghai (CN); Jinming Luo, Shanghai (CN)

(21) Appl. No.: 19/274,748

(22) Filed: Jul. 21, 2025

(30) Foreign Application Priority Data
Aug. 12, 2024 (CN) 202411099400.2

(51) Int. Cl. C02F 11/122; C02F 11/147; C02F 103/00

(52) U.S. Cl. CPC C02F 11/122; C02F 11/147; C02F 2103/00

(57) ABSTRACT

A conditioning method for deep dewatering of sludge from municipal wastewater treatment plants is provided. The method includes following steps: firstly, concentrated sludge is conditioned with polyhexamethylene biguanide to form polyhexamethylene biguanide conditioned sludge, subsequently, a pupa shell powder slurry, formed by treating hermetia illucens pupae shells with sulfuric acid, is added to the polyhexamethylene biguanide conditioned sludge to form a combined pupa shell powder slurry-polyhexamethylene biguanide treated sludge, finally, polydimethyldiallylammonium chloride is added to obtain the conditioned sludge, after mechanical dewatering of this conditioned sludge, deeply dewatered sludge is obtained.

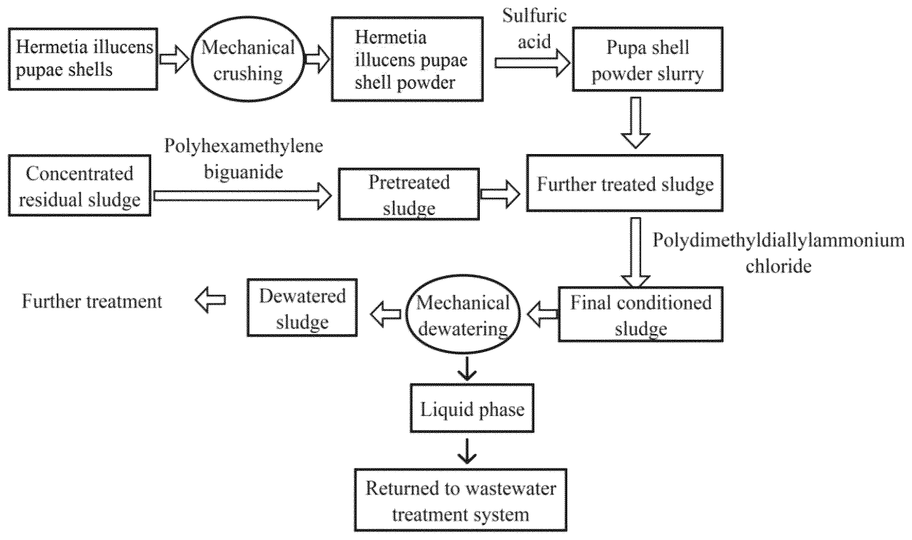

### CROSS-REFERENCE TO RELATED APPLICATIONS

This application claims priority to Chinese Patent Application No. 202411099400.2, filed on Aug. 12, 2024, the contents of which are hereby incorporated by reference.

### TECHNICAL FIELD

The present disclosure relates to the field of environmental engineering technology, and in particular a conditioning method for deep dewatering of sludge from municipal wastewater treatment plants.

### BACKGROUND

Residual sludge is a secondary product generated during the wastewater treatment process in wastewater treatment plants. It has high organic content, and if improperly handled or disposed of, may easily cause secondary pollution. Current sludge disposal methods primarily include land application, incineration, landfill, and utilization in building materials. Among these, landfill and land application require sludge moisture content to be below 60 percent (%), direct incineration requires moisture content below 50%, and utilization in building materials requires moisture content below 40%.

Dewatering is an important means to achieve volume and weight reduction of sludge. However, due to the fine particle size, high viscosity, and strong hydrophilicity of sludge, its dewaterability is very poor. Even with conventional conditioning and mechanical dewatering, the moisture content of the sludge cake remains as high as around 80%. Generally, sludge composting requires the moisture content to be reduced to 50%-60%; disposal by mixing into landfill sites requires the moisture content to be reduced to below 60%; while for incineration treatment, the requirements for moisture content control are even stricter. Therefore, the deep dewatering treatment of sludge is crucial.

The key to achieving deep dewatering of sludge lies in improving its dewaterability. Currently, technologies available on the market that may reduce the moisture content of dewatered sludge to below 60% are primarily realized by adding large amounts of inorganic agents such as lime and iron salts to the sludge followed by high-pressure filtration. However, the dewatering products have high inorganic content and low calorific value, making them unsuitable for land application or incineration treatment. Under the background that landfill disposal is becoming increasingly unpopular, it is crucial to develop technologies that minimize the use of inorganic agents while significantly enhancing sludge dewaterability.

### SUMMARY

The objective of the present disclosure is to provide a conditioning method for deep dewatering of sludge from municipal wastewater treatment plants, so as to solve the problems existing in the prior art mentioned above. The method reduces the moisture content of sludge and simultaneously minimize the addition of inorganic agents, thereby enabling the sludge to meet the requirements for subsequent treatments such as composting and incineration.

To achieve the above objective, the present disclosure provides the following scheme:

the present disclosure provides a conditioning method for deep dewatering of sludge from municipal wastewater treatment plants, including the following steps:

(1) adding a polyhexamethylene biguanide solution to concentrated sludge from the municipal wastewater treatment plants to form polyhexamethylene biguanide treated sludge;

(2) adding pupa shell powder slurry and polydimethyldiallylammonium chloride to the polyhexamethylene biguanide treated sludge to adjust a potential of Hydrogen (pH) of the sludge be 6.1-6.8 to obtain conditioned sludge;

a method for preparing the pupa shell powder slurry includes following steps: grinding hermetia illucens pupae shells, and adding sulfuric acid for soaking to obtain the pupa shell powder slurry; and (3) dewatering the conditioned sludge obtained in the step (2) using a high-pressure plate-and-frame filter press to obtain deeply dewatered sludge.

In an embodiment, in the step (2), a mass concentration of the sulfuric acid is 30 percent (%), a weight-to-volume ratio (W/V) of the hermetia illucens pupae shells to the sulfuric acid is 30%-60%, and the duration time for soaking is at least 60 minutes (min); optionally 70-90 min, more optionally 75 min.

In an embodiment, in the step (2), an addition amount of the pupa shell powder slurry in the polyhexamethylene biguanide treated sludge is at a volume percentage of 0.5%-2%; and a mass-to-volume percentage addition amount of polydimethyldiallylammonium chloride is 0.1%-0.3% of a volume of the polyhexamethylene biguanide treated sludge In an embodiment, in the step (1), polyhexamethylene biguanide is added in the form of an aqueous solution; where a mass concentration of the polyhexamethylene biguanide solution is 10%.

In an embodiment, a volume percentage addition amount of the polyhexamethylene biguanide solution in the concentrated sludge is 0.5%-1.0%.

In an embodiment, a moisture content of the concentrated sludge from the municipal wastewater treatment plants is 97%-98%.

The present disclosure first conditions concentrated sludge with polyhexamethylene biguanide to form polyhexamethylene biguanide conditioned sludge. The pupa shell powder slurry, formed by treating hermetia illucens pupae shells with sulfuric acid, is then added to the polyhexamethylene biguanide conditioned sludge to form a combined pupa shell powder slurry-polyhexamethylene biguanide treated sludge. Finally, polydimethyldiallylammonium chloride is added to obtain the conditioned sludge. This conditioned sludge is then subjected to mechanical dewatering to obtain deeply dewatered sludge with a moisture content of around 60%.

The technical principles of the present disclosure are as follows.

Polyhexamethylene biguanide is a type of green and environmentally friendly bactericide. The addition of polyhexamethylene biguanide to sludge may destroy the permeability of bacterial cell membranes, causing the release of cytoplasm from sludge bacteria into the environment. Furthermore, the hydrophilic groups formed after its ionization in water possess strong positive charges, which may alter the Zeta potential of the sludge, promote sludge flocculation, and thereby significantly improving sludge dewaterability.

Hermetia illucens pupae shells contain substances similar to chitin. Their acid-leached products possess numerous hydrophilic groups such as hydroxyl groups (—OH) and amino (—NH₂). The addition of polyhexamethylene biguanide further enhances sludge dewaterability. After conditioning with these two substances, the dewaterability of the sludge is greatly improved. Subsequent flocculation with the polydimethyldiallylammonium chloride flocculant, followed by dewatering using a high-pressure plate-and-frame filter press, the moisture content may be reduced to around 60%.

More specifically, the technical scheme of the present disclosure includes the following steps:

(1) the discarded shells remaining after hermetia illucens pupae shells extraction are ground using a crusher to achieve a particle size of 1.0-10 micrometers, yielding pupa shell powder. The pupa shell powder is then mixed with sulfuric acid (30% concentration) at a mass-to-volume ratio of 30%-60% and treated for 70-90 min to form pupa shell powder slurry.

(2) Polyhexamethylene biguanide is dissolved in tap water to prepare a 10% solution. The concentrated sludge with a moisture content of 97%-98% from the wastewater treatment plants is transferred into a storage tank. A volume ratio (V/V) of 0.5%-1.0% of polyhexamethylene biguanide aqueous solution is then added based on the sludge volume. The mixture is stirred at a rate of 60-120 revolutions per minute (rpm) for 2-5 min to form polyhexamethylene biguanide conditioned sludge.

(3) The pupa shell powder slurry is added in the polydimethyldiallylammonium treated sludge at a volume ratio of 0.5%-2.0% (V/V), and after mixing evenly, polydimethyldiallylammonium chloride is added at a mass volume ratio of 0.1%-0.3% (W/V). At this point, the pH of the sludge is 6.1-6.8, and the conditioned sludge is obtained.

(4) The conditioned sludge is pumped into a high-pressure plate-and-frame filter press for dewatering treatment to form a sludge cake with a moisture content of 60%, yielding the deeply dewatered product.

The present disclosure has the following technical effects.

The deep dewatering method for sludge according to the present disclosure may significantly reduce the moisture content of the sludge while minimizing the addition of inorganic dewatering agents, thereby enabling the sludge to readily meet the requirements for subsequent treatments such as composting and incineration.

The present disclosure provides a new technical approach for addressing current sludge disposal methods like landfill, composting, and incineration, offering advantages such as low cost, simple operation, and significant effectiveness.

### BRIEF DESCRIPTION OF THE DRAWING

To describe the technical scheme in the embodiments of the present disclosure or the prior art more clearly, the following will briefly introduce the drawing required for describing the embodiments. Obviously, the drawing in the following description is only some embodiments of the present disclosure. For those skilled in the art, other drawings may be derived from these drawings without creative effort.

The figure is the process flow diagram of the present disclosure.

### DETAILED DESCRIPTION OF THE EMBODIMENTS

Various exemplary embodiments of the present disclosure are now described in detail. This detailed description should not be construed as limiting the disclosure but rather as providing a more detailed description of certain aspects, characteristics, and implementations of the present disclosure.

It should be understood that the terminology used herein is only for describing specific embodiments and is not intended to limit the present disclosure. Furthermore, for numerical ranges recited herein, it should be understood that each intervening value between the upper and lower limits of the range is also specifically disclosed. Any stated value or intervening value within a stated range, and any smaller range defined by any other stated value or intervening value within said range, are also included in the present disclosure. The upper and lower limits of these smaller ranges may be independently included or excluded from the range.

Unless otherwise indicated, all technical and scientific terms used herein have the same meaning as commonly understood by one of ordinary skill in the art to which this disclosure belongs. Although only preferred methods and materials are described herein, any methods and materials similar or equivalent to those described herein may be used in the practice or testing of the present disclosure. All publications mentioned herein are incorporated by reference to disclose and describe methods and/or materials related to the referenced publications. In case of conflict with any incorporated publication, the content of this specification shall prevail.

Numerous modifications and variations of the specific embodiments described in this specification may be made without departing from the scope or spirit of the present disclosure, as will be apparent to those skilled in the art. Other embodiments apparent to those skilled in the art from the description herein are intended to be within the scope of the claims. The specification and embodiments are illustrative only.

Regarding the terms “comprising,” “including,” “having,” “containing,” etc., used herein, these are open-ended terms, meaning including but not limited to.

### Embodiment 1

A conditioning method for deep dewatering of sludge from municipal wastewater treatment plants includes following steps: (as shown in the figure)

(1) concentrated sludge with a moisture content of 97 percent (%) from the wastewater treatment plants is treated by adding 0.5% (Volume/Volume (V/V)) of a polyhexamethylene biguanide aqueous solution (10 weight percent (wt %)), followed by mixing at a stirring speed of 90 revolutions per minute (rpm) for 3 minutes (min) to form polyhexamethylene biguanide treated sludge.

(2) Preparation of pupa shell powder slurry: the discarded shells remaining after hermetia illucens pupae extraction are ground using a crusher to achieve a particle size of 1 micrometer, yielding pupa shell powder; then sulfuric acid (the mass concentration is 30%) is added into the pupa shell powder, where the weight-to-volume ratio (W/V) of the pupa shell powder and sulfuric acid is 30%; and the pupa shell powder slurry is formed after treatment for 30 min.

(3) The pupa shell powder slurry is added in the polyhexamethylene biguanide treated sludge obtained in the step (1) at a ratio of 0.5% (V/V), after mixing uniformly, 0.2% (W/V) of polydimethyldiallylammonium chloride is added. At this point, the pH of the sludge is 6.4, and the conditioned sludge is obtained.

(4) The conditioned sludge is pumped into a high-pressure plate-and-frame filter press for dewatering treatment to form a sludge cake with a moisture content of 58%. The dry basis calorific value of the dewatered cake is as high as 2130 kilocalorie per kilogram (Kcal/kg). The organic content and dry basis calorific value are almost identical compared to the dry basis calorific value of the sludge before treatment (concentrated sludge with 97% moisture content).

### Embodiment 2

A conditioning method for deep dewatering of sludge from municipal wastewater treatment plants includes following steps: (as shown in the figure)

(1) concentrated sludge with a moisture content of 97% from wastewater treatment plants is treated by adding 1.0% (V/V) of a polyhexamethylene biguanide aqueous solution (10 wt %), followed by mixing at a stirring speed of 90 rpm for 3 min to form polyhexamethylene biguanide treated sludge.

(2) Preparation of pupa shell powder slurry: the discarded shells remaining after hermetia illucens pupae extraction are ground using a crusher to achieve a particle size of 8 micrometers, yielding pupa shell powder; then sulfuric acid (the mass concentration is 30%) is added into the pupa shell powder, where the weight-to-volume ratio (W/V) of the pupa shell powder and sulfuric acid is 30%; and the pupa shell powder slurry is formed after treatment for 45 min.

(3) The pupa shell powder slurry is added in the polyhexamethylene biguanide treated sludge obtained in the step (1) at a ratio of 2% (V/V), after mixing uniformly, 0.2% (W/V) of polydimethyldiallylammonium chloride is added. At this point, the pH of the sludge is 6.4, and the conditioned sludge is obtained.

(4) The conditioned sludge is pumped into a high-pressure plate-and-frame filter press for dewatering treatment to form a sludge cake with a moisture content of 55%. The dry basis calorific value of the dewatered cake is as high as 2090 Kcal/kg. The organic content and dry basis calorific value are almost identical compared to the dry basis calorific value of the sludge before treatment (concentrated sludge with 97% moisture content).

### Embodiment 3

A conditioning method for deep dewatering of sludge from municipal wastewater treatment plants includes following steps: (as shown in the figure)

(1) concentrated sludge with a moisture content of 98% from the wastewater treatment plants is treated by adding 1% (V/V) of a polyhexamethylene biguanide aqueous solution (10 wt %), followed by mixing at a stirring speed of 90 rpm for 3 min to form polyhexamethylene biguanide treated sludge.

(2) Preparation of pupa shell powder slurry: the discarded shells remaining after hermetia illucens pupae shells extraction are ground using a crusher to achieve a particle size of 10 micrometers, yielding pupa shell powder, then sulfuric acid (the mass concentration is 30%) is added into the pupa shell powder, where the weight-to-volume ratio (W/V) of the pupa shell powder and sulfuric acid is 30%; and the pupa shell powder slurry is formed after treatment for 90 min.

(3) The pupa shell powder slurry is added in the polyhexamethylene biguanide treated sludge obtained in the step (1) at a ratio of 0.5% (V/V), after mixing uniformly, 0.2% (W/V) of polydimethyldiallylammonium chloride is added. At this point, the pH of the sludge is 6.4, and the conditioned sludge is obtained.

(4) The conditioned sludge is pumped into a high-pressure plate-and-frame filter press for dewatering treatment to form a sludge cake with a moisture content of 53%. The dry basis calorific value of the dewatered cake is as high as 2150 Kcal/kg. The organic content and dry basis calorific value are almost identical compared to the dry basis calorific value of the sludge before treatment (concentrated sludge with 97% moisture content).

### Embodiment 4

A conditioning method for deep dewatering of sludge from municipal wastewater treatment plants includes following steps: (as shown in the figure)

(1) concentrated sludge with a moisture content of 98% from the wastewater treatment plants is treated by adding 1% (V/V) of a polyhexamethylene biguanide aqueous solution (10 wt %), followed by mixing at a stirring speed of 90 rpm for 3 min to form polyhexamethylene biguanide treated sludge.

(2) Preparation of pupa shell powder slurry: the discarded shells remaining after hermetia illucens pupae shells extraction are ground using a crusher to achieve a particle size of 8 micrometers, yielding pupa shell powder; then sulfuric acid (the mass concentration is 30%) is added into the pupa shell powder, where the weight-to-volume ratio (W/V) of the pupa shell powder and sulfuric acid is 30%; and the pupa shell powder slurry is formed after treatment for 75 min.

(3) The pupa shell powder slurry is added in the polyhexamethylene biguanide treated sludge obtained in the step (1) at a ratio of 2% (V/V); after mixing uniformly, 0.2% (W/V) of polydimethyldiallylammonium chloride is added. At this point, the pH of the sludge is 6.4, and the conditioned sludge is obtained.

(4) The conditioned sludge is pumped into a high-pressure plate-and-frame filter press for dewatering treatment to form a sludge cake with a moisture content of 50%. The dry basis calorific value of the dewatered cake is as high as 2110 Kcal/kg. The organic content and dry basis calorific value are almost identical compared to the dry basis calorific value of the sludge before treatment (concentrated sludge with 97% moisture content).

The embodiments described above are merely illustrative of the optional implementations of the present disclosure and are not intended to limit the scope of the disclosure. Without departing from the spirit of the disclosure, various modifications and improvements made to the technical schemes of the present disclosure by those skilled in the art shall fall within the scope defined by the appended claims of the present disclosure.

What is claimed is:

1. A conditioning method for deep dewatering of sludge from municipal wastewater treatment plants, comprising following steps:
(1) adding a polyhexamethylene biguanide solution to concentrated sludge from the municipal wastewater treatment plants to form polyhexamethylene biguanide treated sludge;
(2) adding pupa shell powder slurry and polydimethyldiallylammonium chloride to the polyhexamethylene biguanide treated sludge to adjust a pH of the sludge be 6.1-6.8 to obtain conditioned sludge; and
(3) dewatering the conditioned sludge obtained in the step (2) using a high-pressure plate-and-frame filter press to obtain deeply dewatered sludge;
wherein a method for preparing the pupa shell powder slurry comprises following steps: grinding hermetia illucens pupae shells, and adding sulfuric acid for soaking to obtain the pupa shell powder slurry;
wherein in the method for preparing the pupa shell powder slurry, a mass concentration of the sulfuric acid is 30%, a mass-to-volume ratio of the hermetia illucens pupae shells to the sulfuric acid is 30%-60%, and a duration for soaking is more than 60 min;
wherein in the step (2), an addition amount of the pupa shell powder slurry in the polyhexamethylene biguanide treated sludge is at a volume percentage of 0.5%-2%; and a mass-to-volume percentage addition amount of the polydimethyldiallylammonium chloride is 0.1%-0.3% of a volume of the polyhexamethylene biguanide treated sludge;
wherein a mass concentration of the polyhexamethylene biguanide solution is 10%;
a volume percentage addition amount of the polyhexamethylene biguanide solution in the concentrated sludge is 0.5%-1.0%; and
a moisture content of the concentrated sludge from the municipal wastewater treatment plants is 96%-98%.
